(19) United States
(12) Patent Application Publication
(10) Pub. No.: US 2013/0269385 A1
(43) Pub. Date: Oct. 17, 2013

(54) AIR CONDITIONING SYSTEM FOR UTILIZING OUTSIDE AIR AND AIR CONDITIONING DEVICE THEREOF

(71) Applicants: Masaki Takahashi, Hachioji-shi (JP); Yuichiro Minegishi, Hino-shi (JP); Shunsuke Ohga, Chiba-shi (JP)

(72) Inventors: Masaki Takahashi, Hachioji-shi (JP); Yuichiro Minegishi, Hino-shi (JP); Shunsuke Ohga, Chiba-shi (JP)

(73) Assignee: FUJI ELECTRIC CO., LTD, Kawasaki-shi, (JP)

(21) Appl. No.: 13/993,954

(22) PCT Filed: Mar. 14, 2012
(86) PCT No.: PCT/JP2012/056510

§ 371 Date: Jun. 25, 2013

(30) Foreign Application Priority Data
Mar. 14, 2011 (JP) 2011-055589

(51) Int. Cl. G06F 1/20

(52) U.S. Cl. CPC G06F 1/206
USPC 62/513; 165/104.14

(57) ABSTRACT

An air conditioning system for utilizing outdoor air to cool an interior space has a rack for mounting a heating element, a unitized air conditioning device having a pair of unit portions including an interior unit and an exterior unit, and a partition wall disposed between the interior and exterior units. The unitized air conditioning device is disposed so that an air supply face of the interior unit faces an air inlet face of the rack. The exterior unit includes a first fan and a first heat exchanger for exchanging heat between the outdoor air and a refrigerant. The interior unit includes a second heat exchanger for exchanging heat between returning air and the refrigerant to generate cool air, and a second fan. The unitized air conditioning device includes a piping connected to the first heat exchanger and second heat exchanger for circulating the refrigerant.

### TECHNICAL FIELD

The present invention relates to an air conditioning system that utilizes outdoor air.

### BACKGROUND ART

Conventionally, a large number of computers (server devices), or the like, have been installed, for example, in a server room, or the like, of a data center or business. The temperature of this kind of server room rises due to the heat generated by the large number of server devices, and there is a possibility of the server devices going out of control or breaking down due to this temperature rise. Because of this, an air conditioning system that maintains a constant temperature of the whole room is employed in the server room. Also, this kind of air conditioning system operates almost constantly and operates even during winter.

A conventional air conditioning system for this kind of server room, or the like, is such that, in order to achieve stability of the server room temperature, low temperature air (cold air) blown out from an air conditioning device and supplied to the inside of the server room flows while contacting with the server devices in a server rack, thereby cooling the server devices. Because of this, there is obtained a circulation system whereby air (warm air) warmed by the heat of the server devices is returned from the server room to the inside of the air conditioning device, cooled by the air conditioning device, becoming cold air again, and blown out, so that the cold air is again supplied to the inside of the server room, or the like.

Also, an air conditioner described in, for example, PTL 1 is known.

An air conditioning system whereby, when the outdoor air temperature is lower than the temperature of the returning air from the server room (for example, in winter, or the like), an exchange of heat is carried out between the outdoor air and the returning air using a sensible heat exchanger, and cooling of the returning air is carried out without being affected by the outdoor air temperature, is disclosed in PTL 1. Also, a server room air conditioner is provided on the downstream side of the sensible heat exchanger.

By providing the sensible heat exchanger, it is possible to utilize the outdoor air in cooling the inside of the server room without causing the outdoor air to flow into the server room. This kind of method is called indirect outdoor air cooling (an indirect outdoor air introduction method), or the like.

Meanwhile, conventionally, as a method of utilizing outdoor air in cooling the inside of a server room, there has also been known a method whereby outdoor air is caused to flow into the server room, and cooling of the inside of the room (cooling of the server devices) is carried out directly by the outdoor air. This kind of method is called direct outdoor air cooling (a direct outdoor air introduction method), or the like.

Generally, the direct outdoor air introduction method is more efficient than the indirect outdoor air introduction method, but on the other hand, problems occur in that humidity control is essential (basically, humidifying is necessary in winter, and dehumidifying in summer), measures against dust and salt damage are necessary as dust, and the like, flows into the server room, and the like. Because of this, the number of components increases, and time, effort, and cost are needed for maintenance. PTL 1: JP-A-2010-144949

### SUMMARY OF INVENTION

Herein, FIG. 5 shows a configuration example of a conventional indirect outdoor air cooling system.

The indirect outdoor air cooling system shown in the drawing can also be regarded as a simplified configuration of PTL 1.

The indirect outdoor air cooling system of the example shown in FIG. 5, being a cooling system that cools any interior space, is a system that utilizes outdoor air in cooling the interior space without causing the outdoor air to flow into the interior space. The interior space is, for example, a server room, or the like, in which are installed a large number of server racks 202 in which heating elements 201 such as server devices (computer devices) are mounted. In this kind of interior space in which a large amount of heat is generated by the large number of heating elements 201, cooling is necessary even in the winter.

In the embodiment shown in the drawing, the interior space described above is divided into a server installation space, an underfloor space, and a space above the ceiling. Of these, the server installation space is a space installed with the server racks 202 in which the heating elements 201 are mounted. Also, as shown in the drawing, the space above the ceiling is on the upper side of the server installation space, while the underfloor space is on the lower side of the floor. Obviously, holes are opened in the floor and ceiling, and cold air and warm air flow into and out of the server installation space through the holes.

The indirect outdoor air cooling system of the example shown in the drawing, for example, cools returning air (warm air) from the server room, or the like, using an air conditioning device 210 (formed of a refrigerator 211, an air handling unit 212 (incorporating an evaporator, a fan, and the like), an expansion valve 213, a refrigerant pipe 214, and the like) of a general vapor compression type refrigeration cycle. By lowering the temperature of the returning air with an indirect outdoor air cooler 220 installed in the stage before the air handling unit 212 of the air conditioning device (on the upstream side of the warm air flow), utilizing outdoor air, a saving of energy is achieved. The refrigerator 211 has a compressor, a condenser, a fan (air blower), and the like.

The indirect outdoor air cooler 220 has a heat exchanger 221, a fan 222, a fan 223, an indoor air duct 224, an outdoor air duct 225, and the like. The indoor air duct 224 is such that one end thereof is provided on the side of the space above the ceiling, while the other end thereof is provided on the air handling unit 212 side, and it is connected partway along to the heat exchanger 221. Warm air on the side of the space above the ceiling is caused to flow into the indoor air duct 224, and to be exhausted on the air handling unit 212 side, by the fan 222, but the warm air passes through the heat exchanger 221 on the way.

Also, holes are opened in two places optionally in a wall (one is called an outdoor air inflow hole 226, while the other is an exhaust air evacuation hole 227), wherein one end of the outdoor air duct 225 is connected to the outdoor air inflow hole 226, while the other end is connected to the exhaust air evacuation hole 227. Also, the outdoor air duct 225 is connected partway along to the heat exchanger 221. Outdoor air is caused to pass through the outdoor air duct 225 by the fan 223. That is, the outdoor air is caused to flow in from the outdoor air inflow hole 226, and to be exhausted from the exhaust air evacuation hole 227, but the outdoor air passes through the heat exchanger 221 on the way. That is, indoor air (warm air) and the outdoor air pass through the heat exchanger 221, and an exchange of heat between the indoor air (warm air) and outdoor air is carried out in the heat exchanger 221.

Although the heretofore known indirect outdoor air cooling system is shown simplified in the drawing, in reality, it takes up a large installation space. In particular, although shown simplified in the drawing, the ducts (the indoor air duct 224 and outdoor air duct 225) actually take up a large installation space (because of duct wiring installation, partition plate installation, and the like).

Also, when adding server devices, the need to increase air conditioning capability may arise and, although it is conceivable to, for example, increase the number of the indirect outdoor air cooler 220, increasing the number of the indirect outdoor air cooler 220 is difficult with the heretofore known configuration. This is because, as heretofore described, a large installation space is necessary because of the duct wiring installation, partition plate installation, and the like. Because of this, increasing the number of the indirect outdoor air cooler 220 is difficult and, even supposing that an increase is possible, installation costs will be high. Also, as a large amount of outdoor air is needed, it is necessary to make the outdoor air inflow hole 226, and the like, as large as possible (a large aperture is needed).

Also, when the ducts are long, efficiency decreases due to pressure loss and the like.

The heretofore described problems not being limited to the indirect outdoor air cooler 220, essentially the same also applies to the direct outdoor air cooling (direct outdoor air introduction method).

An object of the invention is to provide an air conditioning system for utilizing outdoor air, an air conditioning device thereof, and the like, wherein an air conditioning system that cools an interior by utilizing outdoor air is such that the air conditioning device is unitized, the configuration can be essentially ductless, and time and effort needed for installation can be reduced, meaning that installation costs are low, and flexibility in installation is high.

An air conditioning system for utilizing outdoor air of the invention is an air conditioning system for utilizing outdoor air to cool an interior space installed with a rack for mounting a heating element, and has the following configuration.

That is, firstly, a rack row is formed by a plurality of racks, and the rack row is disposed substantially parallel to a partition wall forming the interior space. Further, a unitized air conditioning device corresponding to each of one or more of the rack is disposed along the line of the partition wall. In particular, the air conditioning device is disposed in the vicinity of the rack so that an air supply face of the air conditioning device faces an air inlet face of the rack.

Further, each air conditioning device takes in outdoor air from outside the partition wall, utilizes the outdoor air to generate cold air, and supplies the cold air from the air supply face to the one or more racks to which the device corresponds.

Alternatively, an air conditioning system for utilizing outdoor air of the invention is an air conditioning system to cool an interior space installed with a rack for mounting a heating element, and has the following configuration.

That is, firstly, a unitized air conditioning device corresponding to each of one or more of the rack is disposed in the vicinity of the rack so that an air supply face of an interior unit of the air conditioning device faces an air inlet face of the rack.

The air conditioning device has a pair of unit portions provided on an interior side and an exterior side sandwiching a partition wall, these being the interior unit provided on the interior side and an exterior unit provided on the exterior side.

Further, the exterior unit has a first fan that intakes and exhausts the outdoor air and a first heat exchanger for exchanging heat between the taken in outdoor air and a refrigerant. Also, the interior unit has a second heat exchanger for exchanging heat between returning air returned from the rack and the refrigerant, thereby cooling the returning air to become cold air, and a second fan that outputs the cold air from the air supply face.

Furthermore, the configuration is such that piping for circulating the refrigerant to the first heat exchanger and second heat exchanger is provided to connect the first heat exchanger and second heat exchanger.

Also, it is preferable that a partition plate that prevents returning air exhausted from the rack and returned to the interior unit from mixing with cold air output from the air supply face is further provided, for example, between the interior unit and the rack in the outdoor air-utilizing air conditioning system with the heretofore described configuration.

### BRIEF DESCRIPTION OF DRAWINGS

FIGS. 1(a) and 1(b) are configuration diagrams of an outdoor air-utilizing air conditioning system of the embodiment.

FIGS. 2(a) and 2(b) are a specific example of a data center to which the outdoor air-utilizing air conditioning system of the embodiment is applied.

FIG. 3 is a diagram showing a detailed configuration example of an air conditioning device.

FIG. 4 is a modified embodiment of the air conditioning device.

FIG. 5 is a configuration example of a conventional indirect outdoor air cooling system.

### DESCRIPTION OF EMBODIMENTS

Hereafter, referring to the drawings, a description will be given of an embodiment of the invention.

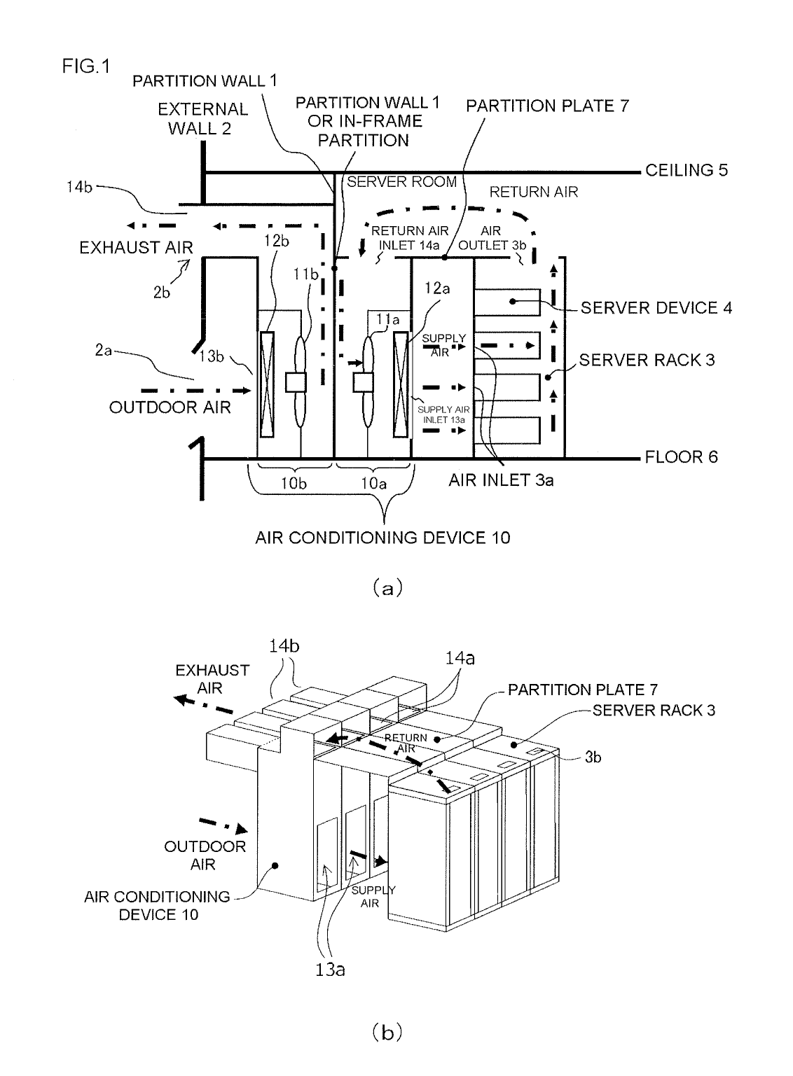

FIGS. 1(a) and 1(b) are configuration diagrams of an air conditioning system for utilizing outdoor air of this embodiment.

FIG. 1(a) is a sectional view, while FIG. 1(b) is a perspective view.

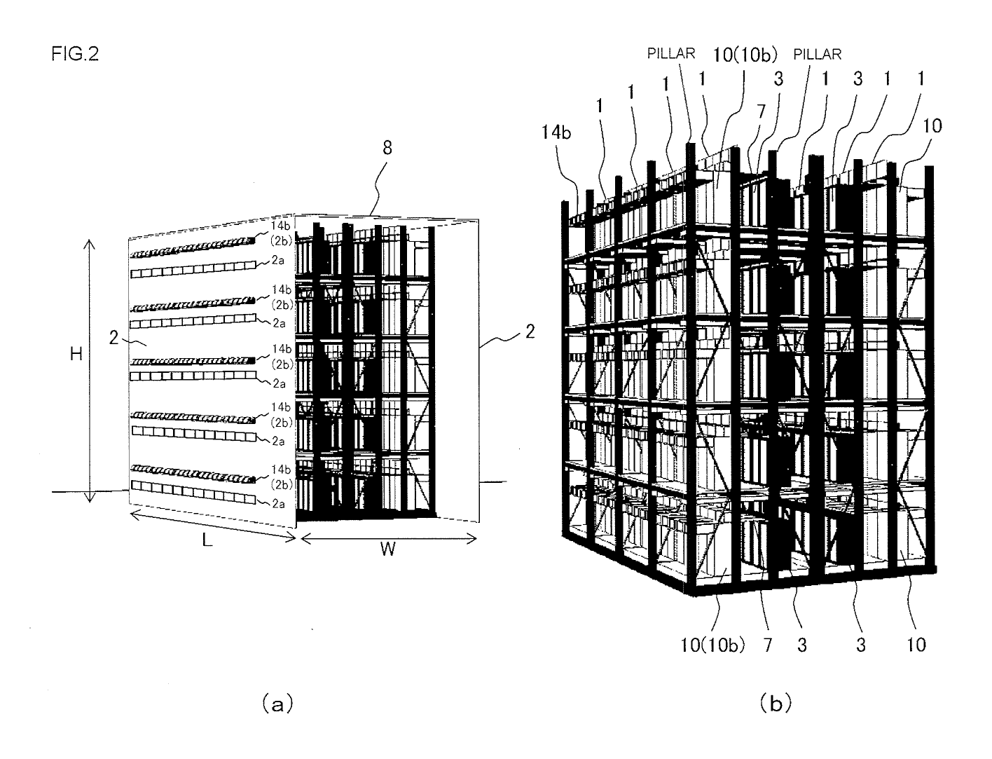

Also, FIGS. 2(a) and 2(b) show a specific example of a data center to which the air conditioning system for utilizing outdoor air of this embodiment is applied. FIGS. 2(a) and 2(b) are a typical example, and will be called a warehouse type modular data center. As a typical example, with regard to a length L, a width W, and a height H of the overall modular data center, there is no particular limitation with respect to the length L and height H, but with respect to the width W, it is preferable as a typical example that the size is such that there are two rows of a server rack 3, as shown in FIGS. 2(a) and 2(b). However, the embodiment is, of course, not limited to this. The server rack 3 is a rack for mounting a server device 4, which is one example of a heating element.

Also, the server device 4 is a typical example of a heating element, but this embodiment is not limited to this. The heating element may be some kind of electronic instrument, or the like. Also, the server rack 3 is a typical example of “a rack housing a heating element”, but this embodiment is not limited to this. The server rack 3 is of, for example, a substantially cuboid form, but this embodiment is not limited to this. Basically, the server rack 3 is such that a plurality of server racks 3 is set aligned in a predetermined direction, thus forming a row (such that a server rack row is formed).

Hereafter, referring to FIGS. 1(a) and 1(b) and FIGS. 2(a) and 2(b), a description will be given of the configuration of the outdoor air-utilizing air conditioning system of the embodiment. In FIGS. 1(a) and 1(b), the flow of air is shown by dot-dashed line arrows.

Firstly, it may be assumed that there are two rows of server racks in the typical example shown in FIGS. 2(a) and 2(b), as heretofore described, and that an example of the configuration of the outdoor air-utilizing air conditioning system relating to either one of the two rows (on the left side of the drawing) is shown in FIGS. 1(a) and 1(b).

That is, a server rack row formed of four server racks 3 is shown as an example of the optional one server rack row in FIG. 1(b), and four air conditioning devices 10 provided corresponding one to each of the four server racks 3 are also shown. Each of the four air conditioning devices 10 is unitized, and each has the same configuration.

An external wall 2, partition wall 1, ceiling 5, floor 6, and the like, shown in FIG. 1(a) and the like are omitted from FIG. 1(b).

Each of the four air conditioning devices 10 is installed in the vicinity of the corresponding server rack 3, and in particular, a cold air supply face (to be described hereafter) of the air conditioning device 10 is installed so as to oppose an air inlet face (to be described hereafter) of the corresponding server rack 3. The four air conditioning devices form a row, as shown in the drawing, thus forming an air conditioning device row. The air conditioning device row is a row substantially parallel to the server rack row. In other words, this means that both the air conditioning device row and server rack row are rows substantially parallel to the partition wall 1, to be described hereafter.

In this example, each air conditioning device 10 is an indirect outdoor air cooling device that cools indoor air (returning air (warm air) from the server rack 3; hereafter referred to as returning air) utilizing outdoor air, without allowing the outdoor air to flow into the interior. The cooled indoor air (cold air) is supplied to the server rack 3, and cools the server device 4 mounted in the server rack 3, because of which the temperature of the air rises, and the air becomes warm air. As the server device 4 acts as a heating element during operation, cooling is necessary.

The heretofore described example not being limited to this, there may also be an example wherein the air conditioning device 10 is a direct outdoor air cooling device, as in a modified embodiment to be described hereafter.

FIG. 1(a) may be regarded as being a sectional view of, for example, the optional server rack 3 and air conditioning device 10 corresponding to the server rack 3 in FIG. 1(b).

Each air conditioning device 10 is installed along the line of the partition wall 1. That is, for example, the air conditioning device 10 is disposed so that the partition wall 1 is sandwiched by two units 10a and 10b, as will be described hereafter. By so doing, the air conditioning device row forms a row substantially parallel to the partition wall 1, as heretofore described.

As shown in FIG. 1(a), the air conditioning device 10 can be divided into an interior side unit (called the interior unit 10a) and an exterior side unit (called the exterior unit 10b) sandwiching the partition wall 1. The interior unit 10a is provided inside a space (server room) in which the server rack 3 is installed. Meanwhile, the exterior unit 10b is installed in a space between the partition wall 1 and external wall 2, outside the server room.

Herein, the server room is assumed to mean a space enclosed by the partition wall 1, ceiling 5, and floor 6. The partition wall 1 not being only the partition wall 1 shown in the drawing on the left side of the server rack 3 in the drawing, an unshown partition wall 1 also exists on the right side of the server rack 3. Because of this, it can also be said that the partition wall 1 forms the server room (the interior space that is to be cooled). Also, as outdoor air may exist on the outer side of the partition wall 1, it can also be said that the partition wall 1 shields the server room from the outdoor air.

At this point, a description will be given of the partition wall 1 and external wall 2, referring to FIGS. 2(a) and 2(b).

As already described, FIG. 2 is perspective views showing a warehouse type modular data center, wherein FIG. 2(a) is an external view and FIG. 2(b) is a transparent view.

The warehouse type modular data center shown in the drawing is of an substantially cuboid form of “length L×width W×height H”, as shown in the drawing, and with regard to the height H, can be regarded as being a five-story construction. The server rack 3 and air conditioning device 10 are installed forming rows on each story, as shown in the drawing.

The external wall 2 in the lateral direction (the width W) is omitted from FIG. 2(a). In FIG. 2(b), not only the external wall 2 in the lateral direction, but also the external wall 2 in the longitudinal direction (the length L) is omitted, and furthermore, a ceiling wall 8 is also omitted (consequently, FIG. 2(b) may be seen as a transparent view). Of the faces of the approximate cuboid, a lateral direction face may also be called a front face, while a longitudinal direction face may also be called a side face. Further, the front faces and side faces of the approximate cuboid are all covered by the external wall 2, but the external wall 2 of the front face is omitted from FIG. 2(a) (in actuality, it exists).

In FIG. 2(b), the partition wall 1 is provided on the interior side of the external wall 2 (one pillar to the interior in the example shown in the drawing), as shown in the drawing. Although outdoor air may flow into the space between the external wall 2 and partition wall 1, the outdoor air does not flow into the space (the server room) to the interior of the partition wall 1.

As shown in FIG. 2(a), an outdoor air inlet hole 2a and outdoor air outlet hole 2b are opened in the side face external wall 2 for each air conditioning device 10, as shown in the drawing.

Herein, as shown in FIG. 1(a), the exterior unit 10b has a first fan 11b and a first heat exchanger 12b. Also, an outdoor air inlet 13b and outdoor air outlet 14b are provided in a frame of the exterior unit 10b. The outdoor air outlet 14b protrudes outward from the outdoor air outlet hole 2b, as shown in the drawing.

A flow of air (outdoor air) shown by a dot-dashed line arrow in the drawing is formed by outdoor air being caused by the first fan 11b to flow from the outdoor air inlet 13b to the inside of the frame and to pass through the first air exchanger 12b, after which it is exhausted from the outdoor air outlet 14b. As the outdoor air inlet 13b is provided in a position facing the outdoor air intake hole 2a of the external wall 2, outdoor air flowing in from the outdoor air intake hole 2a flows directly from the outdoor air inlet 13b to the inside of the frame of the exterior unit 10b.

The outdoor air taken in from the outdoor air inlet 13b passes through the first heat exchanger 12b but, at this time, an exchange of heat, to be described hereafter, is carried out with a refrigerant (cold water, or the like). Hereafter, a description will be given of an embodiment when using cold water as one example of a refrigerant. When the temperature of the outdoor air is lower than the temperature of the cold water, a cooling of the cold water is carried out in the first heat exchanger 12b by the outdoor air.

In this way, the exterior unit 10b takes in outdoor air via the outdoor air inlet hole 2a and outdoor air inlet 13b and, after a heat exchange is carried out in the first heat exchanger 12b, exhausts the air from the outdoor air outlet 14b.

Herein, the exterior unit 10b is installed so that, for example, one face of the frame of the exterior unit 10b closely contacts with the partition wall 1 (the exterior side face thereof), as shown in the drawing. The interior unit 10a is also installed so that one face (which will be called the back face) of the frame of the interior unit 10a closely contacts with the partition wall 1 (the interior side face thereof).

However, the heretofore described example not being limited to this, the air conditioning device 10 may also be of, for example, an integrated unit configuration wherein the exterior unit 10b and interior unit 10a are not separated. In this case, for example, by a hole of a size around the same as that of the interior unit being provided in positions all over the partition wall 1, and the interior unit of the integrated unit being inserted into the hole (for example, being inserted from the exterior side), it is possible to install the air conditioning device 10 in substantially the same state as in FIG. 1(a).

With regard to a portion in which the integrated unit is installed in this case, the partition wall 1 between the exterior unit 10b and interior unit 10a shown in FIG. 1(a) does not exist (it becomes the heretofore described “hole”). Instead, when the integrated unit is manufactured in advance in a factory, or the like, an unshown “in-frame partition” is provided in order to separate the exterior unit and interior unit in the integrated unit.

As is clear from the above, “the partition wall 1 or an in-frame partition” exists between the exterior unit 10b and interior unit 10a, as shown in FIG. 1(a).

Although the heretofore described configuration examples are not limited to this, it is necessary to configure so that outdoor air does not flow into the interior unit 10a or server room.

Next, a description will be given of the interior unit 10a.

In the example shown in FIG. 1(a), the interior unit 10a has a second fan 11a and a second heat exchanger 12a. Also, a supply air inlet 13a and a return air inlet 14a are provided in a frame of the interior unit 10a. In the example shown in the drawing, the return air inlet 14a is provided in the upper face of the frame of the interior unit 10a, while the supply air inlet 13a is provided in the front face (supply air face), but this embodiment is not limited to this. However, as heretofore described, it is necessary to provide the interior unit 10a so that the air supply face (supply air inlet 13a) faces the air inlet face (an air inlet 3a, to be described hereafter) of the server rack 3.

A flow of air such that the indoor air of the server room passes through the inside of the interior unit 10a is formed by the second fan 11a. That is, there is formed a flow of indoor air such that exhaust air (returning air) from the server rack 3 flows into the interior unit 10a from the return air inlet 14a, becomes cold air by passing through the second heat exchanger 12a, and is output from the supply air inlet 13a.

Herein, the first heat exchanger 12b and second heat exchanger 12a are connected to unshown piping, and the heretofore described liquid (herein, cold water is taken as an example) circulates through the first and second heat exchangers 12b and 12a via the piping. Because of this, an exchange of heat is carried out between the cold water and outdoor air in the first heat exchanger 12b, as heretofore described. In the same way, an exchange of heat is carried out between the cold water and returning air in the second heat exchanger 12a. This means that an exchange of heat is indirectly carried out between the outdoor air and returning air via the cold water, and basically, the returning air is cooled and turned into cold air by the outdoor air.

As heretofore described, basically, the cold water is cooled by the outdoor air in the first heat exchanger 12b, and the cooled cold water is supplied to the second heat exchanger 12a. Because of this, basically, the returning air is cooled by the cold water in the second heat exchanger 12a, whereby cold air is generated. The cold air generated is output from the supply air inlet 13a.

Herein, as shown in FIG. 1(a), the interior unit 10a is provided in the vicinity of the server rack 3, and is disposed in a way such that the air supply face (the face in which is the supply air inlet 13a) faces the air inlet face (the face in which is the air inlet 3a) of the server rack 3. Also, an air outlet 3b is provided in the upper face (ceiling face) on the rear side of the server rack 3. However, this embodiment not being limited to this, the air outlet 3b may be provided in the back face of the server rack 3. Herein, the intake face is regarded as being the front face, and the face on the opposite side (the face on the rear side) is the back face.

For example, a fan not shown is provided in the server rack 3, air (cold air) is drawn in from the air inlet 3a by the fan, and the air, after passing through each of the server device 4 mounted in the server rack 3, is exhausted from the air outlet 3b. The cold air passes through the server device 4, which is a heating element, thereby cooling the server device 4, as well as which the temperature of the air rises, and the air becomes warm air and is exhausted from the air outlet 3b.

Herein, for example, by adopting the configuration shown in FIGS. 2(a) and 2(b) as the overall configuration, it is possible to form a row of server racks 3 in the vicinity of the partition wall 1 in a form along the line of the partition wall 1. As there are two side faces, the partition wall 1 also has two faces, and by a row of server racks being formed for each partition wall 1 along the line of the partition wall 1, there are two rows of server racks, as heretofore described. Also, as the air conditioning device 10 is installed in a way such as to sandwich the partition wall 1, as heretofore described, an air conditioning device row is also formed for each partition wall 1 along the line of the partition wall 1. Therefore, there are also two air conditioning device rows in the heretofore described example. Further, as already described, the server rack row and air conditioning device row are substantially parallel to each partition wall 1.

Further, it is possible to install one air conditioning device 10 in the vicinity of one server rack 3, as in the example shown in, for example, FIG. 1. Further, as already described, the air conditioning device 10 can be installed so that the cold air supply face of the air conditioning device 10 faces the cold air inlet face of the corresponding server rack 3.

According to the heretofore described configuration, the distance between each server rack 3 and the corresponding air conditioning device 10 is extremely short in comparison with that heretofore known, and it is thus easier to supply cold air. That is, as the cold air output from the supply air inlet 13a of the interior unit 10a substantially flows directly into the air inlet 3a in the air inlet face of the opposing server rack 3, without passing through a duct, underfloor space, or the like, there is low pressure loss, and efficiency (air supply efficiency, and the like) is high.

Also, as the distance between each server rack 3 and the corresponding air conditioning device 10 is extremely short in comparison with that heretofore known, there is also low pressure loss and high efficiency with regard to returning air collection. That is, returning air exhausted from the server rack 3 can be caused to flow substantially directly into the return air inlet 14a of the air conditioning device 10, without passing through a duct, space above the ceiling, or the like.

Also, with regard to the intake and evacuation of outdoor air too, the exterior unit 10b of each air conditioning device 10 is installed in the vicinity of the external wall 2, meaning that it is installed in a place near the outdoor air space (the outer side of the external wall 2). Therefore, a duct for the intake and evacuation of outdoor air is unnecessary or, even if present, need only be extremely short. Therefore, there is also low pressure loss and high efficiency with regard to the intake and evacuation of outdoor air.

As heretofore described, it can be said that the configuration is such that the distance that all of the outdoor air, cold air, and returning air flow need only be extremely short in comparison with that heretofore known, it is possible to realize an essentially ductless state, there is low pressure loss, and efficiency is high. By the air conditioning device being unitized in this way, and installation being essentially ductless, a small installation space is sufficient, low installation costs are sufficient, and there is also high flexibility in installation.

With regard to flexibility in installation, for example, the warehouse type modular data center shown in FIG. 2 is such that, it not necessarily being the case that the server racks 3 are installed to the maximum from the outset, vacant space often exists. The air conditioning device 10 is not installed for this kind of vacant space. Then, every time a server rack 3 is subsequently added, a new air conditioning device 10 corresponding to the newly installed server rack 3 is added. As the expansion work at this time is done by unit and is ductless, the work is easy, and the burden and cost of the work can be reduced.

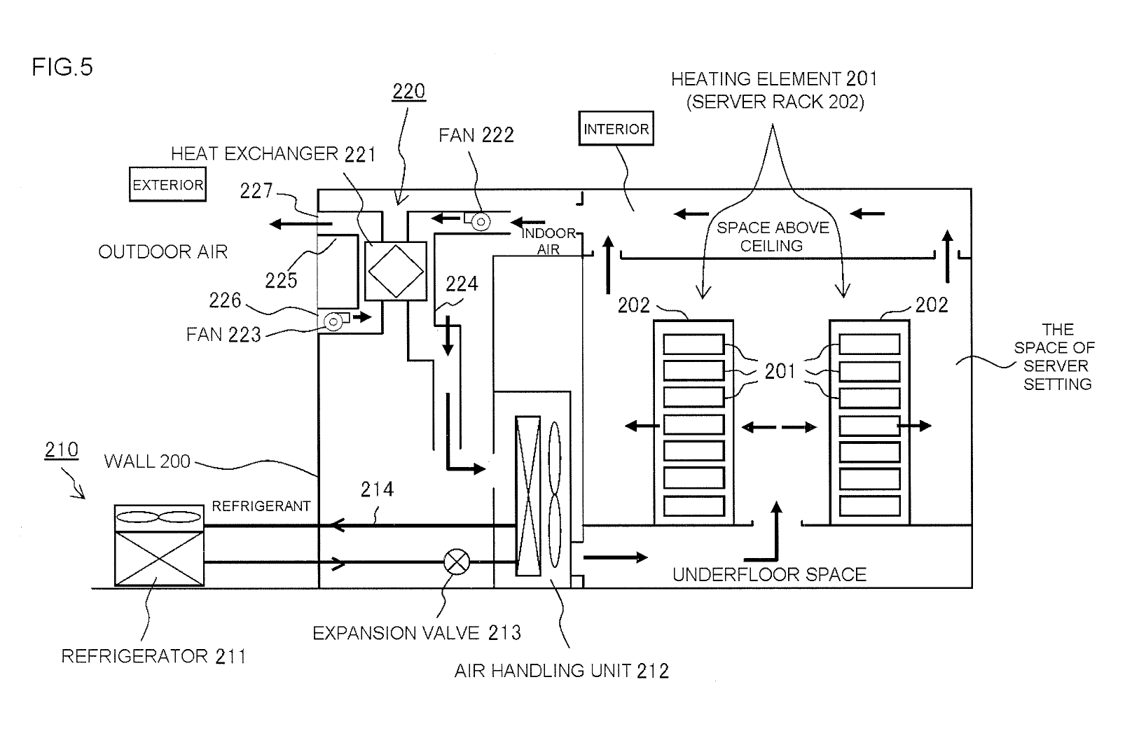

Regarding the previous statement that “the air conditioning device 10 (the interior unit 10a) is provided in the vicinity of the server rack 3”, no specific numerical value for “vicinity” is shown. That is, there is no particular restriction on the distance between the interior unit 10a and the server rack 3. In any case, as shown in FIG. 1 and the like, the distance between the cold air output vent (the supply air inlet 13a) of the air conditioning device, and the like, and the server rack (the air inlet face thereof) is extremely short in comparison with a heretofore known example shown in FIG. 5 and the like.

Herein, as heretofore described, cold air flowing into the server rack 3 from the air inlet 3a thereof passes through each server device 4, thereby cooling the server device 4, because of which the temperature of the air rises, the air becomes warm air, and is exhausted from the air outlet 3b. This warm air, as heretofore described, is drawn into the return air inlet 14a of the interior unit 10a, but there is a possibility of one portion of the warm air flowing into a space between the interior unit 10a and server rack 3 (a space into which cold air is supplied from the supply air inlet 13a; this will be called cold space), and mixing with the cold air, thereby raising the temperature of the cold air.

In order to prevent this kind of situation, in this example, a partition plate 7 is provided between the interior unit 10a and server rack 3 (on the upper portions thereof), as shown in FIGS. 1(a) and 1(b). In the example shown in the drawings, the partition plate 7 is installed in a way such that one end thereof is connected to the upper portion of the interior unit 10a, while the other end is connected to the upper face (ceiling face) of the server rack 3. Because of this, returning air exhausted from the air outlet 3b of the server rack 3 passes above the partition plate 7, and flows into the return air inlet 14a of the interior unit 10a. When the returning air passes above the cold space, the presence of the partition plate 7 means that the returning air does not flow below the partition plate 7 (into the cold space) (even in the event that returning air does flow into the cold space, the amount is small). By providing the partition plate 7 in this way, it is possible to prevent the kind of situation wherein warm air mixes with cold air (even in the event that warm air mixes with cold air, the amount is small).

As heretofore described, by providing the partition plate 7, it is possible to separate cold air and warm air so that the two do not mix. As the interior unit 10a is provided in the vicinity of the server rack 3, it is sufficient that the partition plate 7 is also short in length, meaning that the cost thereof is low, and installation is easy.

The heretofore described configuration being one example, the configuration is not limited to this. For example, in the heretofore described example, the air conditioning device 10 is provided for each server rack 3. That is, when there are M server racks 3, there are also M air conditioning devices 10 (M is an optional integer). However, this embodiment not being limited to this, for example, when there are M server racks 3, there may be M/2, M/3, or the like, air conditioning devices 10. In other words, one air conditioning device 10 may be provided for every two server racks 3, or one air conditioning device 10 may be provided for every three server racks 3, or the like.

Further, for the configuration wherein one air conditioning device 10 is provided for one server rack, it is preferable to adopt a configuration wherein, for example, the width of the air conditioning device 10 is substantially the same as the width of the server rack 3. In the same way, for the configuration wherein one air conditioning device 10 is provided for every two server racks 3, or one air conditioning device 10 is provided for every three server racks 3, it is preferable to adopt a configuration wherein, for example, the width of the air conditioning device 10 is an integral multiple (two times or three times) of the width of the server rack 3. That is, in terms of efficiently supplying cold air, reducing deviation of the cold air supply, and the like, it is preferable to configure so that the width of the air conditioning device 10 is substantially the same as the overall width of the one or more server racks 3 to which the air conditioning device 10 corresponds (which the air conditioning device 10 cools).

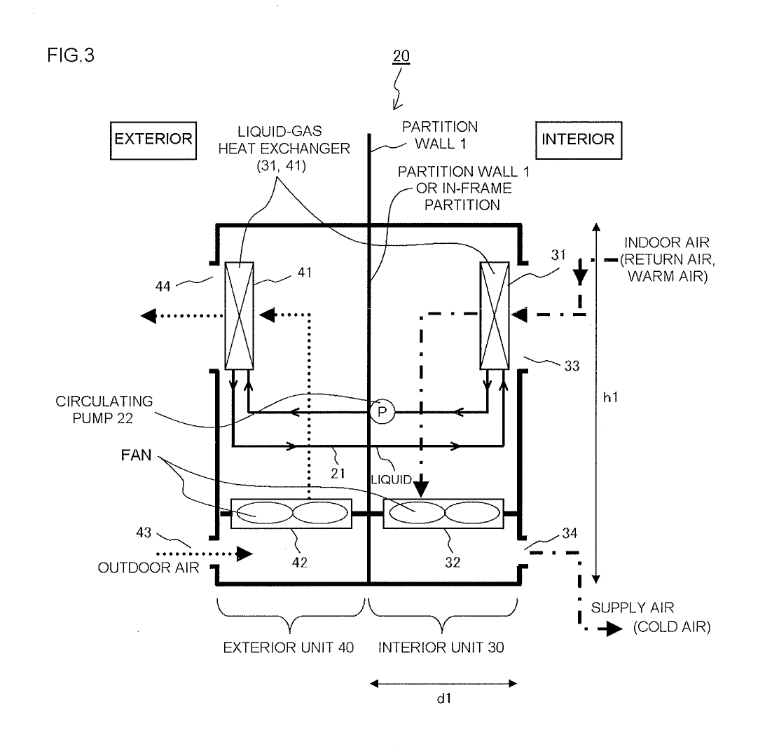

Herein, FIG. 3 shows a more detailed configuration example of the air conditioning device. This is a more detailed configuration example of the air conditioning device as an indirect outdoor air cooler.

An indirect outdoor air cooler 20 shown in the drawing is formed of an interior unit 30 and an exterior unit 40. As heretofore described, the air conditioning device 10 of FIG. 1 and FIG. 2 is formed, as one example, of the interior unit 10a and exterior unit 10b, and configuration examples corresponding to the interior unit 10a and exterior unit 10b are the interior unit 30 and exterior unit 40 of FIG. 3. Furthermore, in this description, basically, with regard to “the partition wall 1 or an in-frame partition”, an example wherein this is not “an in-frame partition” (therefore, it is the partition wall 1; in other words, it is not an integrated unit) will be used. Consequently, as shown in FIG. 3, the interior unit 30 is installed so as to be in close contact with the interior side wall surface of the partition wall 1, while the exterior unit 40 is installed so as to be in close contact with the exterior side wall surface of the partition wall 1.

The interior unit 30 has, for example, a liquid-gas heat exchanger 31, a fan 32, piping 21 (one portion thereof, in the region of a half), and a circulating pump 22, shown in the drawing.

The exterior unit 40 has, for example, a liquid-gas heat exchanger 41, a fan 42, and piping 21 (one portion thereof, in the region of a half), shown in the drawing.

The piping 21 is connected to the liquid-gas heat exchanger 31 and liquid-gas heat exchanger 41, and the circulating pump 22 is provided on the piping 21. Liquid (for example, water or cold water) is circulated to the liquid-gas heat exchanger 31 and liquid-gas heat exchanger 41 via the piping 21. The power source for this liquid circulation is the circulating pump 22. Therefore, when wishing to stop the circulation of the liquid, it is sufficient to turn off the circulating pump 22.

Also, indoor air (returning air, warm air) passes through the liquid-gas heat exchanger 31, while outdoor air passes through the liquid-gas heat exchanger 41. Because of this, an exchange of heat between indoor air and cold water is carried out in the liquid-gas heat exchanger 31, while an exchange of heat between outdoor air and cold water is carried out in the liquid-gas heat exchanger 41. Basically, the indoor air (warm air) is cooled by the cold water, whereby cold air is generated, and the cold water whose temperature has risen because of this is cooled by the outdoor air.

When the interior unit 30 is manufactured in a factory or the like, for example, the liquid-gas heat exchanger 31, fan 32, and the like, shown in the drawing are provided in a box-like frame of which one face is opened. Also, holes (an indoor air inlet 33 and an indoor air outlet 34) shown in the drawing are opened in the frame of the interior unit 30.

The liquid-gas heat exchanger 31, fan 32, indoor air inlet 33, and indoor air outlet 34 are configurations corresponding to the second heat exchanger 12a, second fan 11a, return air inlet 14a, and supply air inlet 13a respectively of FIG. 1(a).

In the same way, when the exterior unit 40 is manufactured in a factory or the like, for example, the liquid-gas heat exchanger 41, fan 42, and the like, shown in the drawing are provided in a box-like frame of which one face is opened. Also, holes (an outdoor air inlet 43 and an outdoor air outlet 44) shown in the drawing are opened in the frame of the exterior unit 40.

The fan 42, liquid-gas heat exchanger 41, outdoor air inlet 43, and outdoor air outlet 44 are configurations corresponding to the first fan 11b, first heat exchanger 12b, outdoor air inlet 13b, and outdoor air outlet 14b respectively of FIG. 1(a).

The interior unit 30 and exterior unit 40 are both installed so that the open face is aligned with a wall surface of the partition wall 1.

Further, it is necessary when installing that through holes for the piping 21 to pass through are opened in two places in the partition wall 1 (of course, the through holes may be opened in advance all over the partition wall 1, but it will be necessary to block the through holes by some method in places in which the indirect outdoor air cooler 20 is not installed). Also, in the event that the piping 21 (one portion thereof, in the region of a half) has already been provided in each of the interior unit 30 and exterior unit 40 when manufacturing in the factory, the “piping 21 partway along which the circulating pump 22 is provided” shown in the drawing may be formed by welding, or the like, the two portions of the piping 21 (at this time, the circulating pump 22 is also connected).

The indirect outdoor air cooler 20 is configured by installing the interior unit 30 and exterior unit 40 in the way heretofore described.

As heat exchange is carried out in the indirect outdoor air cooler 20 with outdoor air and indoor air cut off from each other, outdoor air humidity, dust, and corrosive gas included in the outdoor air are not taken into the server room, because of which the reliability of an electronic instrument such as a server is maintained.

“The bulkhead 1 or an in-frame partition” is written between the interior unit 30 and exterior unit 40 in FIG. 3 for the same reason that “the partition wall 1 or an in-frame partition” is written in FIG. 1(a). That is, the indirect outdoor air cooler 20 may be of an integrated configuration wherein the interior unit 30 and exterior unit 40 are integrated. In this case, a partition is provided in order to separate the interior unit 30 portion and exterior unit 40 portion in the interior. Then, the piping 21 is caused to penetrate the partition (the circulating pump 22 too is already provided). The indirect outdoor air cooler 20 with this kind of configuration is manufactured in advance at a factory or the like.

Further, when assuming that the frame of the interior unit 30 has a width w1, a height h1, and a depth d1, holes of a size w1×h1 are provided in advance all over the partition wall (note that these are blocked by plates, or the like, until installation). Then, when installing the indirect outdoor air cooler 20, it is possible to carry out the installation of the indirect outdoor air cooler 20 by inserting the interior unit 30 of the indirect outdoor air cooler 20 in the above-mentioned hole from, for example, the exterior side, or the like, thereby attaining the condition shown in FIG. 3. Consequently, in this case, there is no need to open through holes for the piping 21 in the partition wall 1, and no need either for the work of passing the piping 21 through the through holes, meaning that the installation work can be more easily carried out.

Next, a description will be given hereafter of a modified embodiment.

As an overall view and perspective view of the modified embodiment may be substantially the same as FIGS. 2(a) and 2(b) and FIG. 1(b), they will be omitted. However, as the modified embodiment is such that outdoor air flows into the server room, the partition wall 1 is not needed.

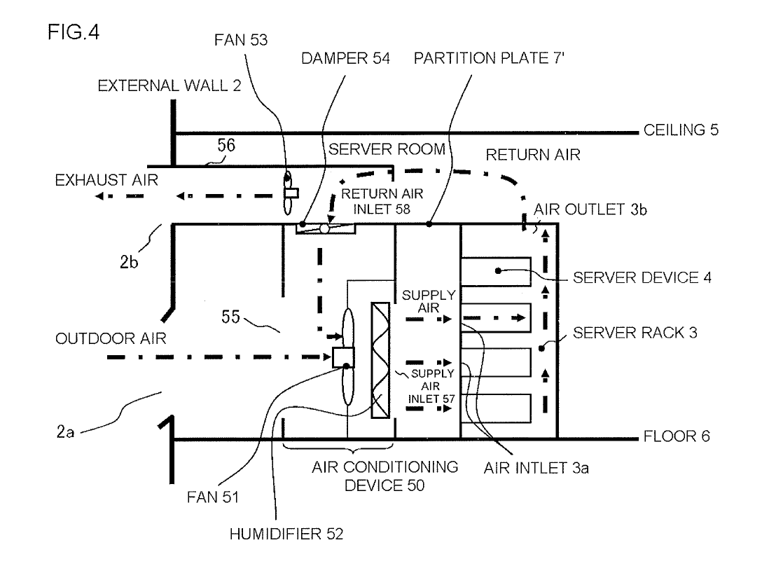

FIG. 4 shows a sectional view of an air conditioning device 50 of the modified embodiment.

In FIG. 4, components essentially the same as components in the sectional view of the air conditioning device 10 shown in FIG. 1(a) are given the same reference signs, and a description thereof will be simplified or omitted.

The air conditioning device 50 of the modified embodiment is a direct outdoor air cooler, wherein outdoor air flows into the server room. Then, the server device 4 is cooled by the outdoor air flowing in.

In FIG. 4, firstly, as the disposition and configuration of the server rack 3 (including the server device 4, which is a heating element; the server device 4 may be shown as a heat generating element 4) are essentially the same as in FIG. 1(a), they are given the same reference signs, and a description thereof will be omitted. Also, with regard to the external wall too, as it is essentially the same as in FIG. 1(a), it is given the same reference sign, and a description thereof will be omitted.

As heretofore described, the partition wall 1 is not needed in the modified embodiment, and FIG. 4 shows a configuration example wherein there is no partition wall 1. Further, in the example shown in FIG. 4, the air conditioning device 50 is installed in an optional position (for example, the position shown in the drawing) in a space between the external wall 2 and server rack 3. Note that, while saying “an optional position”, when the overall configuration is the example of FIG. 2 (note that the partition wall 1 is omitted from the configuration of FIG. 2), the space between the external wall 2 and server rack 3 will at least not be wide (basically, it is narrow).

Consequently, basically, the distance between the air conditioning device 50 and server rack 3 and the distance between the air conditioning device 50 and external wall 2 are both short. In other words, it can be said that the air conditioning device 50 too, in essentially the same way as the air conditioning device 10, is installed in the vicinity of the server rack 3, and is installed in the vicinity of the external wall 2 (near the external wall space). Furthermore, in essentially the same way as the air conditioning device 10, it is preferable that the air conditioning device 50 is installed in a way such that an air supply face (an air inlet 57) of the air conditioning device 50 faces the air inlet face (the air inlet 3a) of the server rack 3.

According to the heretofore described configuration, the modified embodiment too is such that a short distance is sufficient for both the intake and evacuation of outdoor air and the supply of outdoor air (cold air) to the server rack 3 according to the air conditioning device 50, and it is possible to realize an essentially ductless configuration, as shown in FIG. 4.

Herein, the air conditioning device 50 is such that the air inlet 57 is opened in a lower portion of the front face (air supply face) of the frame of the air conditioning device 50, as shown in the drawing, and a return air inlet 58 is opened in an upper portion of the front face of the frame of the air conditioning device 50, as shown in the drawing. Furthermore, an outdoor air inlet 55 is opened in a lower portion of the back face of the frame of the air conditioning device 50, as shown in the drawing, and an outdoor air outlet duct 56 shown in the drawing is provided in an upper portion of the back face of the frame of the air conditioning device 50.

Further, the outdoor air inlet 55 in particular is provided in a position opposing the outdoor air inlet hole 2a of the external wall 2. Furthermore, the air inlet 57 is also opened in a position corresponding the outdoor air inlet 55 (a position causing outdoor air to be taken in and supplied substantially linearly, as shown by a dot-dashed line arrow shown in the drawing).

Herein, for convenience of description, the face of the frame of the air conditioning device 50 on the server rack 3 side will be called the front face, and the face on the external wall 2 side the back face.

Also, the air conditioning device 50 has a fan 51, a humidifier 52, a fan 53, and a damper 54. The air conditioning device 50 is divided into an upper portion and a lower portion, and the damper 54 is provided at the boundary between the upper portion and lower portion. When the damper 54 is opened, air flows in and out between the upper portion and lower portion. The fan 51 and humidifier 52 are provided in the lower portion, while the fan 53 is provided in the upper portion.

The fan 51 is a fan that forms a flow of air such that outdoor air is taken inside the frame of the air conditioning device 50 through the outdoor air inlet hole 2a and outdoor air inlet 55, and the outdoor air taken in is exhausted from the supply air inlet 57, thereby supplying the air to the air inlet 3a of the opposing server rack 3. As this flow of outdoor air is essentially linear, as heretofore described (as shown by a dot-dashed line arrow shown in the drawing), the air inlet and supply air can be carried out efficiently.

Also, the humidifier 52 is provided somewhere along the flow of outdoor air (before the air inlet 57 in the example shown in the drawing) inside the frame of the air conditioning device 50. Because of this, the outdoor air taken in is humidified by the humidifier 52 before being exhausted from the air inlet 57. However, this embodiment not being limited to this, a dehumidifier may be provided in place of the humidifier 52, or a humidifier-cum-dehumidifier may be provided (it may be assumed that which one is used is optionally determined in accordance with outdoor air conditions such as, in particular, outdoor air humidity).

The outdoor air exhausted from the air inlet 57 passes through the narrow space (the cold space) between the air conditioning device 50 and server rack 3, flows into the server rack 3 from the air inlet 3a of the server rack 3, and passes through the mounted server device 4. Because of this, the server device 4 is cooled by the outdoor air, as well as which the temperature of the outdoor air rises, and the air becomes warm air and is exhausted from the air outlet 3b.

Herein, the fan 53 is a fan for causing returning air exhausted from the air outlet 3b to flow into the upper portion of the air conditioning device 50 from the return air inlet 58, and evacuating the air directly to the outside of the building through the outdoor air outlet duct 56.

Also, in the same way as in FIG. 1, a partition plate 7′ for separating warm air and outdoor air so that the outdoor air and warm air do not mix is provided between the air conditioning device 50 and server rack 3. In other words, it can be said that the partition plate 7′ is installed above the cold space. With the partition plate 7′, it is possible to prevent a situation wherein returning air flows into the cold space. That is, by providing the partition plate 7′, it is possible to prevent a situation such as warm air mixing with outdoor air (cold air) due to returning air flowing into the cold space, the temperature of the air rising, and cooling efficiency decreasing.

The partition plate 7′ shown in the drawing is such that one end thereof is connected to the upper face (ceiling face) of the server rack 3, while the other end thereof is connected to the border between the upper portion and lower portion of the air conditioning device 50. However, this embodiment is not limited to this.

As heretofore described, outdoor air from outside the building is supplied to the server device 4 inside the server rack 3, thereby cooling the server device 4, and returning air from the server rack 3 exhausted to the outside of the building, by the two fans 51 and 53.

By the damper 54 inside the frame of the air conditioning device 50 being opened, it is also possible to cause one portion of the returning air caused to flow into the upper portion of the air conditioning device 50 from the return air inlet 58 to flow into the lower portion of the air conditioning device 50, and to mix with drawn in outdoor air. Because of this, by mixing returning air with outdoor air when, for example, the temperature of the outdoor air is extremely low, or the like, the temperature of the outdoor air supplied to the server device is raised, and it is possible to supply air of a constant temperature, even when using outdoor air whose temperature is liable to fluctuate.

As shown in FIG. 4, the configuration of the modified embodiment is such that, in essentially the same way as in the case of the embodiment shown in FIG. 1 or the like, the air conditioning device 50 is disposed in the vicinity of each server rack 3, and the intake face of the server rack 3 (the intake face of the heating element) and the air supply face of the air conditioning device 50 are disposed facing each other.

Because of this, the configuration may be said to be essentially ductless. That is, with regard to the outdoor air supply, the configuration is ductless. With regard to the exhaust air, although there is the outdoor air outlet duct 56, it need only be extremely short in comparison with a heretofore known duct. Furthermore, it is possible to supply outdoor air directly from the air conditioning device 50 to the server rack (the heating element 4 mounted therein) in a short distance. In this way, this method is such that, there being no decrease in efficiency (air inlet, exhaust air, or supply air efficiency) because of pressure loss, or the like, caused by a long duct, cooling (in particular, cooling of the heating element 4) utilizing outdoor air can be efficiently carried out.

As still another modified embodiment, for example, in addition to the configuration wherein cooling of returning air is carried out by a heat exchange utilizing outdoor air (called an outdoor air-utilizing cooling device), a configuration of an air conditioning device using a general refrigeration cycle such as, for example, a vapor compression type refrigeration cycle may be further provided in the air conditioning device 10 or 50 or the indirect outdoor air cooler 20.

As the cooling capacity of the outdoor air-utilizing cooling device is affected by the temperature, or the like, of the outdoor air, there may be times when it is not possible to keep the inside of the server room at the set temperature (there is insufficient cooling capacity). Because of this, an air conditioning device using a general refrigeration cycle has also been provided heretofore too, as in the example shown in FIG. 5. In this case, even when conditions are such that it is not possible to reduce the returning air to the set temperature by utilizing outdoor air (the outdoor air temperature is high, or the like), the air is caused to flow into the general air conditioning device after the temperature has been reduced to a certain extent, meaning that it is possible to reduce the cooling load of the general air conditioning device, because of which an energy saving effect is obtained.

In the other modified embodiment, this kind of general air conditioning device configuration is provided inside the frame of the air conditioning device 10 or 50 or the indirect outdoor air cooler 20.

Although no particular configuration example of this kind of other modified embodiment is shown, the configuration is such that, for example, an air conditioning device using a vapor compression type refrigeration cycle has components such as an evaporator, a compressor, a condenser, and an expansion valve, wherein a refrigerant is circulated to these components through a refrigerant pipe, as is well known. It is sufficient that these components and the refrigerant pipe are provided inside the frame of the air conditioning device 10 or 50 or the indirect outdoor air cooler 20.

Herein, the air conditioning device 10 and indirect outdoor air cooler 20 are formed of an interior unit and an exterior unit, but the evaporator is provided inside the interior unit, while the condenser is provided inside the exterior unit. The compressor and expansion valve may be provided in either the interior unit or exterior unit.

Further, it is preferable that the evaporator is provided on the downstream side of the heat exchanger (for example, the second heat exchanger 12a). Upstream side and downstream side are defined as the upstream side and downstream side according to the flow of air, and in this case, as the evaporator is inside the interior unit, the upstream side and downstream side are defined according to the flow of air (indoor air; returning air, air after cooling, or the like) passing through the interior unit.

By providing the evaporator on the downstream side of the heat exchanger as heretofore described, it is possible, after returning air is first cooled by the heat exchanger, to cause the returning air to be cooled in the evaporator so as to reach the set temperature.

Also, it can be assumed as one example that the condenser is provided on the downstream side (the downstream side of the flow of outdoor air) of the heat exchanger (for example, the first heat exchanger 12b) inside the exterior unit, but this embodiment is not limited to this.

In the example shown in FIG. 2, rack rows are provided substantially parallel to the external wall 2 (the partition wall 1 substantially parallel thereto) in the longitudinal direction of a building of a substantially cuboid form, and there are therefore two rack rows, but the embodiment is not limited to this. For example, furthermore, rack rows may also be provided substantially parallel to the external wall 2 (the partition wall 1 substantially parallel thereto) in the lateral direction of the building of an substantially cuboid form, whereby a further two rack rows are configured, and a total of four rack rows are formed.

In either case, as the air conditioning device of this embodiment utilizes outdoor air, an intake and evacuation of outdoor air are necessary, and in order to realize this in an essentially ductless form, it is necessary that it is possible to install the air conditioning device near the outdoor air environment (near the external wall 2). Furthermore, in order to efficiently carry out a supply of cold air to the heating element and a collection of returning air, it is necessary that it is possible to install the air conditioning device near the rack in which the heating element is mounted. The configuration of FIG. 2 is a typical example of a configuration wherein it is possible to realize this kind of air conditioning device installation, but the embodiment is not limited to this.

According to the outdoor air utilizing air conditioning system of this embodiment, the following advantages are obtained.

As the outdoor air aperture portion (the outdoor air inlet hole 2a) and the outdoor air introduction face (the outdoor air inlet 13b) of the air conditioning device 10 are disposed facing each other (as they are even closer), and/or as the cold air supply face (the supply air inlet 13a) of the air conditioning device 10 and the cold air inlet face (the air inlet 3a) of the server rack 3 (the heating element 4) are disposed facing each other (as they are even closer), pressure loss is low and efficiency high, and the configuration is essentially ductless, meaning that installation space efficiency is high, and there is no need for underfloor access for installation or the like.
As the width of the air conditioning device 10 is essentially the same as, or an integral multiple of, the width of the server rack 3 (the heating element 4), it is easier to provide the air conditioning device 10 corresponding to each server rack 3 (heating element 4), and an adding of extra air conditioning devices 10 in response to an adding of extra server rack 3 (heating elements 4) can also be easily carried out.
As the partition plate 7 and the like separate warm air and cold air, no system ceiling is necessary.
As no duct construction is needed (or at least, the construction of the heretofore known kind of long duct is unnecessary), installation work becomes easier, as well as which it is possible to reduce installation costs, and a flexible installation can be carried out.
As the air conditioning device 10 is unitized, and each unit is an independent cooling device, no cold infrastructure is necessary, meaning that installation is easier.

According to the outdoor air-utilizing air conditioning system of the invention, the air conditioning device thereof, and the like, an air conditioning system that cools an interior by utilizing outdoor air is such that the air conditioning device is unitized, the configuration can be essentially ductless, and time and effort needed for installation can be reduced, meaning that installation costs are low, and flexibility in installation is high.

1-14. (canceled)

15. An air conditioning system for utilizing outdoor air to cool an interior space, comprising:
at least one rack for mounting a heating element, and having an air inlet face;
a unitized air conditioning device comprising:
a pair of unit portions including an interior unit disposed on an interior side of the air conditioning device and an exterior unit disposed on an exterior side of the air conditioning device;
wherein said exterior unit includes a first fan adapted to intake and exhaust the outdoor air, and a first heat exchanger for exchanging heat between the taken in outdoor air and a refrigerant;
wherein said interior unit includes an air supply face, a second heat exchanger for exchanging heat between returning air returned from the rack and the refrigerant to cool the returning air to generate cold air, and a second fan for outputting the cold air from the air supply face; and
a piping connected to the first heat exchanger and the second heat exchanger for circulating the refrigerant; and
a partition wall disposed between the interior unit and the exterior unit,
wherein the unitized air conditioning device is disposed in a vicinity of the rack so that the air supply face of the interior unit of the air conditioning device is arranged to face the air inlet face of the rack.

16. An air conditioning system for utilizing outdoor air according to claim 15, further comprising a partition plate disposed between the interior unit and the rack, for preventing the returning air exhausted from the rack and returned to the interior unit from mixing with the cold air output from the air supply face.

17. An air conditioning system for utilizing outdoor air according to claim 15, wherein the rack is a plurality of racks forming a rack row substantially parallel to the partition wall,
the air conditioning device is a plurality of air conditioning devices forming an air conditioning device row substantially parallel to the partition wall, provided to correspond to the plurality of racks, and
an external wall is provided substantially parallel to the partition wall on an outer side of the partition wall.

18. An air conditioning system for utilizing outdoor air according to claim 17, wherein the interior space is a space enclosed with the partition wall in a building having the external wail to form a substantially cuboid shape, and
the rack row is disposed substantially parallel to the partition wall provided substantially parallel to the external wall to correspond to the external wall of a predetermined face of the building having the substantially cuboid shape.

19. An air conditioning system for utilizing outdoor air according to claim 17, wherein the exterior unit is disposed in a space between the partition wall and the external wall.

20. An air conditioning system for utilizing outdoor air according to claim 15, wherein a number of the air conditioning devices increases according to an increase in a number of the racks.

21. An air conditioning system for utilizing outdoor air according to claim 15, wherein the interior unit of the air conditioning device has a width substantially same as that of the rack, or has a width with integral multiple of the width of the rack.

22. An air conditioning system for utilizing outdoor air according to claim 18, wherein the air conditioning device is disposed to face an outdoor air inlet opening thereof toward an outdoor air inlet hole placed in the external wall, and
the first and second fans of the air conditioning device are structured to form a substantially linear outdoor air flow to intake the outdoor air through the outdoor air inlet hole and the outdoor air inlet opening, and to output the taken in outdoor air from the air supply face toward the air inlet face, so that the outdoor air is supplied to the rack.

23. An air conditioning system for utilizing outdoor air to cool an interior space, comprising:
a partition wall for forming the interior space;
a plurality of racks for mounting heating elements, and forming a rack row disposed substantially parallel to the partition wall, each rack having an air inlet face; and
unitized air conditioning devices corresponding to the plurality of racks, and disposed along the partition wall and in a vicinity of the racks, each of the air conditioning devices having an air supply face facing each of the air inlet face of the racks,
wherein each of the air conditioning devices is arranged to intake the outdoor air from outside the partition wall, to generate cold air with the outdoor air, and to supply the cold air from the air supply face to the plurality of racks to which the air conditioning device corresponds.

24. An air conditioning system for utilizing outdoor air to cool an interior space, comprising:
at least one rack for mounting a heating element, and comprising an air inlet face; and
a unitized air conditioning device including an air supply face and fans to intake the outdoor air through an external wall and to supply the outdoor air from the air supply face to the at least one rack to which the air conditioning device corresponds, said air conditioning device being disposed in a vicinity of the external wall and in a vicinity of the rack so that the air supply face of the air conditioning device is facing the air inlet face of the rack.

25. An air conditioning system for utilizing outdoor air according to claim 24, wherein a rack row substantially parallel to the external wall is formed with a plurality of the rack, and an air conditioning device row substantially parallel to the external wall and the rack row is formed by a plurality of said air conditioning devices corresponding to each rack.

26. An air conditioning system for utilizing outdoor air according to claim 24, further comprising:
an outdoor air inlet hole provided in the external wall; and
an outdoor air inlet opening disposed to face the outdoor air inlet hole,
wherein the fans of the air conditioning device are arranged to form an essentially linear outdoor air flow to intake the outdoor air through the outdoor air inlet hole and outdoor air inlet opening, and to output the taken in outdoor air toward the air inlet face from the air supply face, so that the rack is supplied with the outdoor air.

27. An air conditioning system for utilizing outdoor air according to claim 24, further comprising a partition plate disposed between the air conditioning device and the rack, for preventing returning air exhausted from the rack and returned to the air conditioning device from mixing with the outdoor air output from the air supply face.

28. An air conditioning device of an air conditioning system for utilizing outdoor air to cool an interior space installed with a plurality of racks having heating elements thereon and forming a rack row disposed substantially parallel to a partition wall forming the interior space, comprising:
an air supply face; and
a cold air supply device structured to intake the outdoor air from outside the partition wall to generate cold air with the outdoor air, and to supply the cold air from the air supply face to the plurality of racks,
wherein the air conditioning device is disposed corresponding to the plurality of racks along the partition wall and in a vicinity of the rack so that the air supply face of the air conditioning device is adapted to face an air inlet face of the rack.
